(19) United States
(12) Patent Application Publication
(10) Pub. No.: US 2009/0158166 A1
(43) Pub. Date: Jun. 18, 2009

(54) METHOD, SYSTEM, AND COMPUTER PROGRAM PRODUCT FOR AUTOMATIC REARRANGEMENT OF MODULES BASED ON USER INTERACTION

(76) Inventors: AMI H. Dewar, Durham, NC (US); Robert C. Leah, Cary, NC (US); Nicholas E. Poore, Durham, NC (US); Peter C. Yim, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/957,103

(22) Filed: Dec. 14, 2007

(51) Int. Cl. G06F 3/00

(52) U.S. Cl. 715/745

(57) ABSTRACT

A method, system, and computer program product for rearranging a plurality of modules displayed on a content aggregated webpage is presented. In an exemplary manner, the method includes monitoring one or more of a plurality of user interactions associated with one or more of a plurality of modules. A rank value is assigned to a particular one of the plurality of modules, whereby rank value assignment is based on the one or more of the plurality of user interactions. Based on the rank value that is assigned to the particular one of the plurality of modules, the particular module is automatically displayed at a particular position on the content aggregated webpage.

### BACKGROUND OF THE INVENTION

The present disclosure relates to the field of computers, and specifically to display tools relating to a content aggregated webpage.

Computer users are increasingly turning to content aggregated webpages to receive data. These content aggregated webpages can be provided by a monolithic source, or increasingly, from a multiple syndicated sources which are collected using a content aggregation application to form a single, integrated webpage. Syndication benefits both the websites providing the information and the websites displaying it. For the receiving site, content syndication is an effective way of adding greater depth and immediacy of information to the receiving site's webpage, making it more attractive to users. For the transmitting site, syndication drives exposure across numerous online platforms, which drives new traffic for the transmitting site and makes syndication a free and easy form of advertisement.

### BRIEF SUMMARY OF THE INVENTION

A method, system, and computer program product for rearranging a plurality of modules displayed on a content aggregated webpage is disclosed. The method includes monitoring one or more of a plurality of user interactions associated with one or more of a plurality of modules. A rank value is assigned to a particular one of the plurality of modules, whereby rank value assignment is based on the one or more of the plurality of user interactions. Based on the rank value that is assigned to the particular one of the plurality of modules, the particular module is automatically displayed at a particular position on the content aggregated webpage.

### BRIEF DESCRIPTION OF THE SEVERAL VIEWS OF THE DRAWINGS

Aspects of the invention itself will best be understood by reference to the following detailed description of an illustrative embodiment when read in conjunction with the accompanying drawings, where:

FIG. 1 depicts an exemplary computer in which the present invention may be implemented;

FIGS. 2A and 2B are graphical representations of an exemplary content aggregated webpage at different time instances, according to an embodiment of the present invention; and

FIG. 3 is a high-level flow-chart of exemplary steps taken by the present invention to rearrange a plurality of modules displayed on a content aggregated webpage.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java® (JAVA is a trademark or registered trademark of Sun Microsystems, Inc. in the United States and other countries), Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

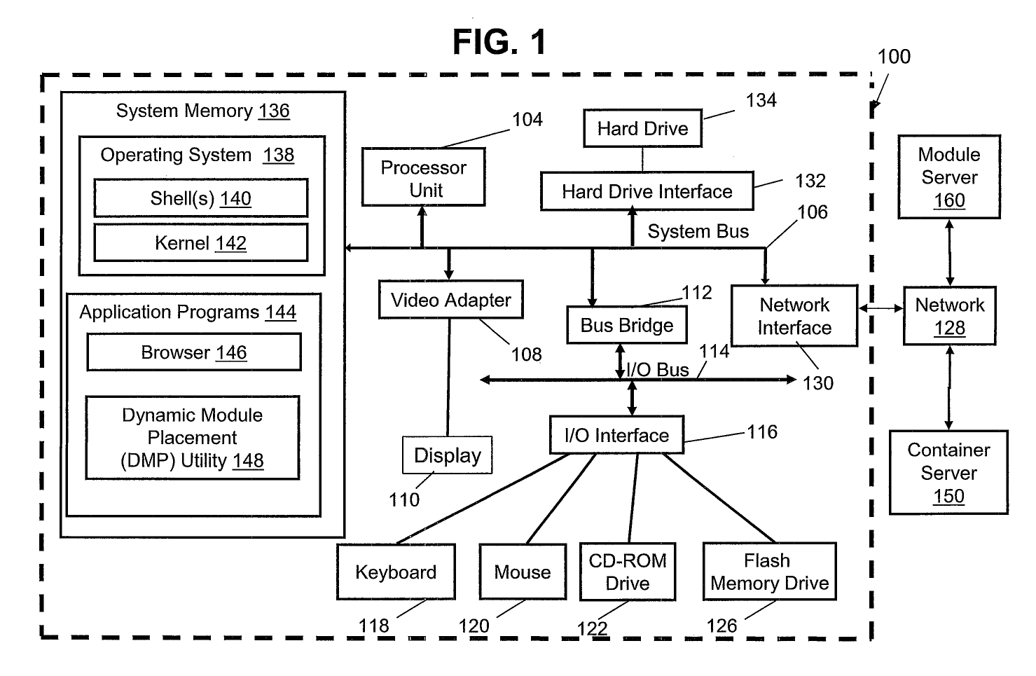

With reference now to the figures, and in particular to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a container server 150 via a network 128 using a network interface 130, which is coupled to system bus 106. Network 128 may be an external network such as the Internet, or an internal network such as an Ethernet or a Virtual Private Network (VPN). Container server 150 may be architecturally configured in the manner depicted for computer 100. Various embodiments provide a protocol for communication between a hosting site (e.g., container server 150) and a module server 160 (e.g., a server operated by an entity other than a user of computer 100 or the hosting site (e.g., container server 150).

Container server 150 serves a container document (e.g., content aggregated webpage comprised of a plurality of modules or personalized webpage) to computer 100 over network 128. The container document “contains” one or more modules, including one or more remote modules. As used herein, the term “container document” or “container” should be understood to include a content aggregated webpage or a personalized homepage of a website, a sidebar, toolbar element that incorporates one or more such modules, a page hosted by a site, a document capable of rendering modules (e.g., any document capable of rendering HyperText Markup Language (HTML) code or Extensible Markup Language (XML) code) in the format of the module (e.g., XML). Also, the container may be a website of another entity that incorporates the modules when the modules are supplied through a syndication system.

As used herein, the term “module” may be understood to refer to a piece of software and/or hardware that renders data for use in a container document. Modules may be personalized to user preferences, preferences of the container, or preferences of the environment or other inputs. A module specification may be understood to include a set of instructions used to render data for the container document using elements that have been predefined.

As used herein, the term “syndication” or “syndicating” may be understood to refer to a remote module being incorporated into a container operated from container server 150, whereby container server 150 is not affiliated with module server 160. Syndication makes web feeds available from a site (module server 160) in order to provide a user of computer 100 with a summary of module server's 160 content. A plurality of these syndicated modules is displayed on a content aggregated webpage hosted by container server 150. Content aggregation web applications, such as mashup applications can be used by container server 150 to combine data from more than one module server 160. Typically, the content used in mashup applications is sourced from a third party (i.e., module server(s) 160) via a public interface or an Application Program Interface (API). Other methods of sourcing content for mashup applications include Web feeds (e.g., using syndications protocols RSS or Atom), web services and screen scraping.

Container server 150 comprises a web server or related server system that takes data and/or instructions and formulates the container for transmission over network 128. However, it should be appreciated that container server 150 may reside on a user's computer 100, such that a network connection may not be used. Module server 160 provides data from modules to container server 150 for incorporation into a container document. It should also be appreciated that in another embodiment, container server 150 and module server 160 can comprise a single unit performing functions from both container server 150 and module server 160. Module server 160 may provide data for the container document by interpreting and/or parsing instructions in a module specification associated with the module.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX® (UNIX is a registered trademark of The Open Group in the United States and other countries)) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

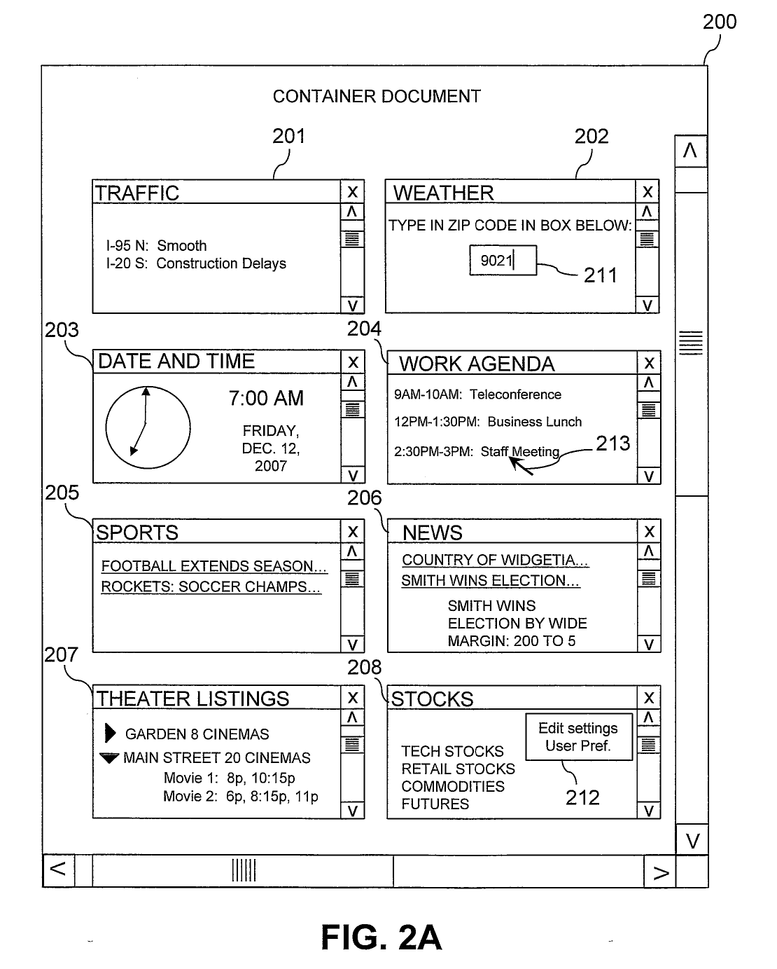

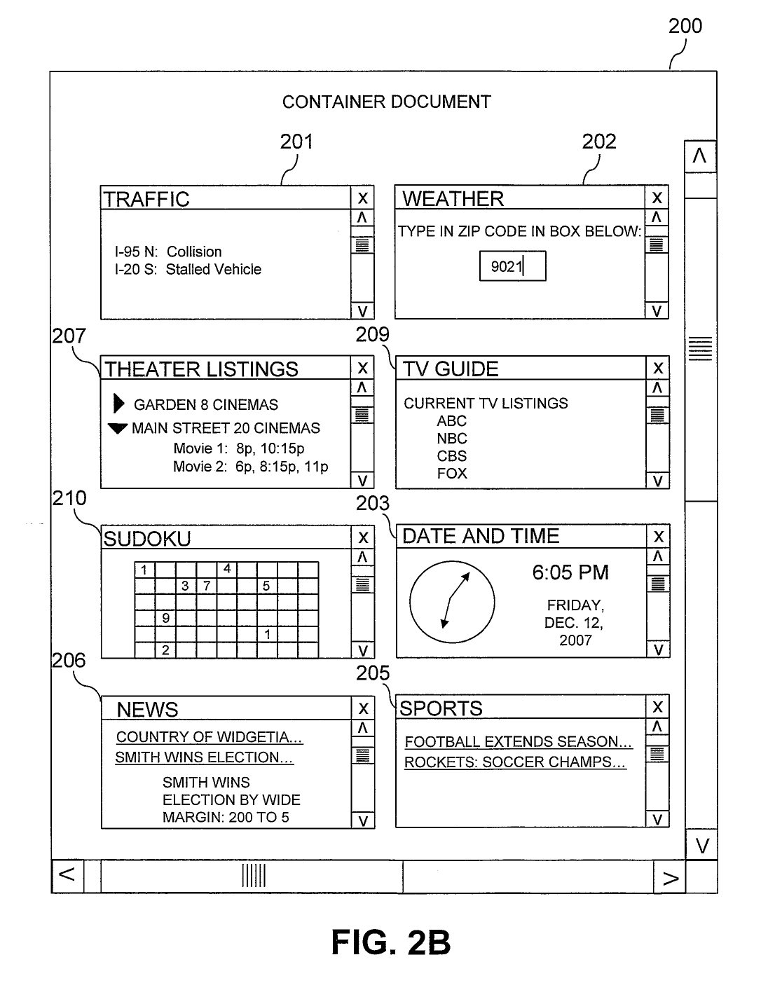

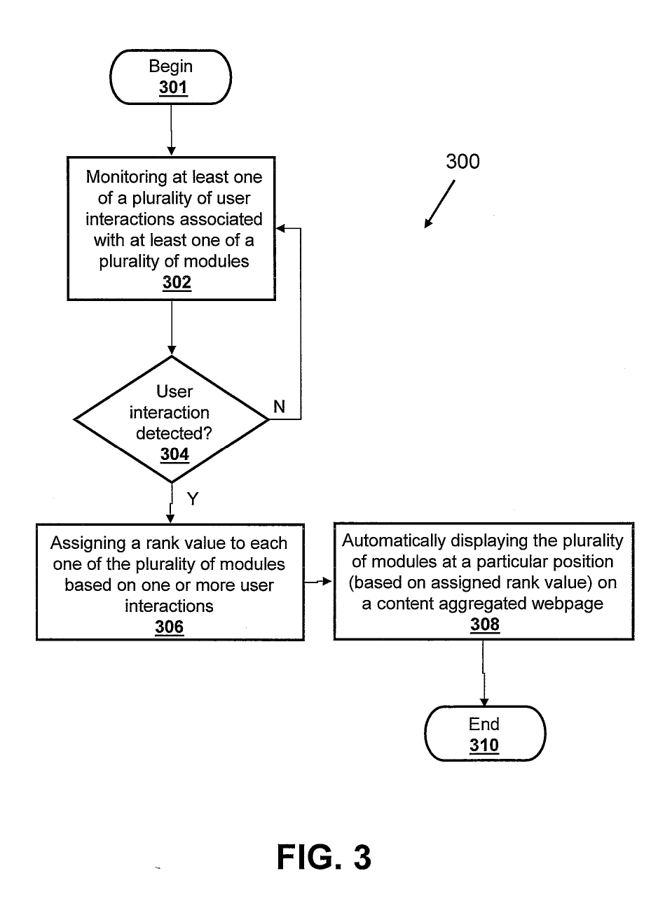

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with container server 150. Application programs 144 in system memory 136 also include a Dynamic Module Placement (DMP) Utility 148. DMP utility 148 performs the functions illustrated below in FIG. 3, and may include all logic, helper functions, databases and other resources depicted below in FIGS. 1-2B. In this regard, HTTP cookies, sometimes known as web cookies or just cookies, can be used to communicate user interaction information associated with one or more modules back to container server 150. The user interaction information that is monitored by DMP utility 148 is communicated via cookies to container server 150. It should be appreciated, however, that DMP utility 148 can reside in memory that is on the server-side, such as container server 150, on the client-side, or a combination thereof.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

Referring now to FIG. 2A, a graphical representation of an exemplary content aggregated webpage 200 (or container document) is shown. Content aggregated webpage 200 includes a plurality of modules 201-208, which are currently displayed to a user. For exemplary purposes, modules currently displayed to the user in FIG. 2A include a Traffic module 201, a Weather module 202, a Date/Time module 203, a Work Agenda module 204, a Sports module 205, a News module 206, a Theater Listings module 207, and a Stocks module 208. However, it should be appreciated that there can be additional modules (e.g., TV Guide module 209 and Sudoku module 210 shown below in FIG. 2B) that have been selected for inclusion in content aggregated webpage 200, but are not currently shown due to the limited display real estate.

Modules 201-210 are initially selected by the user and arranged in grid-fashion on content aggregated webpage 200. In this regard, there are various ways in which modules 201-210 can be arranged on content aggregated webpage 200. One way is to arrange the modules in a first-in, first-out (FIFO), whereby the first module that is selected for placement on container document is initially positioned at the top, left side of container document. Moreover, the display real estate can be subdivided and assigned different position values that are characterized by a column value and a row value. For example, the top, left side of container document is assigned position value (1, 1), which indicates column 1, row 1.

The initial position value associated with a particular module serves as a default initial rank value for the particular module. As additional modules are added to the container document, the previously added module is shifted from its current position (i.e., position value (1, 1)), to the next, less-prominent position value (i.e., position value (1, 2)), which is located at the top, right corner of the container document. As a result, the rank value of the shifted module drops relative to the subsequently added modules. However, the invention is not limited in this regard, and modules 201-210 can be initially positioned in various other ways, which include, but are limited to: a last-in, last-out (LILO) arrangement, manual manipulation by the user, user-selected preferences, and/or syndication-site preferences. In another embodiment, the provider of the content aggregated webpage may initially pre-select and/or pre-arrange a set of modules for display, whereby a user can later modify this pre-selection and/or pre-arrangement.

Once modules 201-210 have been initially selected by a user and positioned on aggregated webpage 200, DMP utility 148 (FIG. 1) monitors one or more user interactions associated with modules 201-210. As used herein, a user interaction is any interaction/gesture produced by a user-input device (i.e., keyboard, mouse, stylus, a light pen, trackball, joystick, or finger) associated with a module. Examples of user interactions include, but are not limited to: expanding/closing a drop-down box (see Theater Listings module 207), inputting text (see box 211 in Weather module 202), clicking on a hyperlink (see Sports module 205), changing settings/preferences of a module (see settings box 212 in Stocks module 208), selecting/highlighting text, focusing a cursor 213 over content in a module (see Work Agenda module 204), or repositioning a module.

The user interactions associated with modules 201-210 determine the assignment of rank values associated with modules 201-210. In this regard, the assignment of rank values can be based on (i) a usage count and/or (ii) a usage pattern of user interactions associated with the various modules. Usage count refers to the number of times one or more user interactions is/are associated with a particular module. For example, if Traffic module 201 is associated with ten user interactions and Stocks module 208 is associated with only one user interaction, Traffic module 201 will thus be assigned a higher rank value, and thus will be displayed at a more prominent position within content aggregated webpage 200, as compared to Stocks module 208. By extension, modules which are not currently visible in content aggregated webpage 200 are assigned a lower rank value.

Another way to assign rank values is by basing the assignment of rank values on a usage pattern of user interactions. The term “usage pattern” refers to a time or seasonal pattern to which certain modules are accessed by a user. To illustrate how usage patterns are employed, FIGS. 2A and 2B depict content aggregated webpage 200 at different time periods within a day. For example, FIG. 2A shows a snapshot of an arrangement of modules 201-210 at a particular time instance (e.g. 7 a.m. on Friday, Dec. 12, 2007). At this particular time instance, an assumption is made that one or more user interactions have been previously monitored over a period of time until a usage pattern can be detected. Thus, a usage pattern will identify modules that would be more likely placed in a more prominent position on a container document than other modules. For instance, at the particular time instance shown in FIG. 2A, Work Agenda module 204 is positioned at position value (2, 2). At the same time, other modules that are not heavily accessed at the time instance shown in FIG. 2A (e.g., TV Guide module 209 and Sudoku module 210) would be assigned a lower ranking relative to other modules. As a result, TV Guide module 209 and Sudoku module 210 are hidden from the viewable region of container document 200. To access TV Guide module 209 and Sudoku module 210, a user would have to scroll down content aggregated webpage 200 to view these modules.

With reference now to FIG. 2B, content aggregated webpage 200 is depicted having a different usage pattern at an associated time instance (e.g., 6:05 p.m. on Friday, Dec. 12, 2007). The associated time instance in FIG. 2B occurs at later time instance than what is depicted in FIG. 2A. For example, Work Agenda module 204 has been reassigned a lower rank value as compared to TV Guide module 209 and Sudoku module 210. As result, Work Agenda module 204 is no longer as prominently positioned as earlier depicted in FIG. 2A. At the same time, TV Guide module 209 and Sudoku module 210 are more prominently placed (i.e., at lower column and row position values) on the display real estate.

In addition to assigning rank values based on the frequency (i.e. usage count) and/or pattern (i.e., usage pattern) of one or more user interactions associated with a module(s), user interactions are themselves assigned weighted values based on the significance of one user interaction as compared to another user interaction. For instance, DMP utility 148 (FIG. 1) can assign a higher weight value (i.e., importance) to a user interaction such as clicking on a hyperlink within a module, versus the user interaction of merely hovering a mouse cursor over content in a module.

As described in exemplary manner below, the present invention provides a method for rearranging a plurality of modules displayed on a content aggregated webpage. With reference now to FIG. 3, a high-level flow-chart of method 300 is shown. After initiator block 301, DMP utility 148 (FIG. 1) monitors for at least one of a plurality of user interactions that are associated with at least one of a plurality of modules 201-210 (FIG. 2). A determination is made whether at least one user interaction is detected, as depicted in decision block 302. If at least one user interaction is not detected, method 300 returns to block 302. However, if at least one user interaction is detected, method 300 continues to block 306, where each one of the plurality of modules are assigned a rank value based on one or more of the detected user interactions. From block 306, method 300 proceeds to block 310, in which the plurality of modules are automatically displayed at a particular position on content aggregated webpage 200. In this regard, it is important to note that the automatic display of modules implies that the modules are either: (i) visibly displayed due to the module's higher rank value or (ii) visibly displayable (though initially hidden from view) by scrolling through content aggregated webpage 200. Method 300 ends at terminator block 310.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for rearranging a plurality of modules displayed on a content aggregated webpage, the method comprising:
monitoring at least one of a plurality of user interactions associated with at least one of a plurality of modules;
assigning a rank value to a particular one of said plurality of modules, wherein said assigning step is based on said at least one of said plurality of user interactions; and
automatically displaying said particular one of said plurality of modules at a particular position on a content aggregated webpage, wherein said particular position is based on said assigned rank value.

2. The method of claim 1, wherein said assigning step is based on a usage count of said at least one of said plurality of user interactions.

3. The method of claim 1, wherein said assigning step is based on a usage pattern of said at least one of said plurality of user interactions.

4. The method of claim 1, wherein said at least one of said plurality of user interactions associated with said module includes: expanding a drop-down box, or closing said drop-down box, or selecting text, or highlighting text, or clicking on a hyperlink, or changing preferences, or inputting text, or focusing an icon over said module, or dragging said module.

5. The method of claim 1, wherein each one of said plurality of user interactions is associated with a weighted value.

6. The method of claim 1, wherein said plurality of modules comprises syndicated modules.

7. A computer program product for rearranging a plurality of modules displayed on a content aggregated webpage, the computer program product comprising:
a computer usable medium having computer usable program code embodied therewith, the computer usable program code comprising:
computer usable code configured for monitoring at least one of a plurality of user interactions associated with at least one of a plurality of modules;
computer usable program code configured for assigning a rank value to a particular one of said plurality of modules, wherein said assigning step is based on said at least one of said plurality of user interactions; and
computer usable program code configured for automatically displaying said particular one of said plurality of modules at a particular position on a content aggregated webpage, wherein said particular position is based on said assigned rank value.

8. The computer program product of claim 7, wherein the assigned rank value is based on a usage count of said at least one of said plurality of user interactions.

9. The computer program product of claim 7, wherein the assigned rank value is based on a usage pattern of said at least one of said plurality of user interactions.

10. The computer program product of claim 7, wherein said at least one of said plurality of user interactions associated with said module includes: expanding a drop-down box, or closing said drop-down box, or selecting text, or highlighting text, or clicking on a hyperlink, or changing preferences, or inputting text, or focusing an icon over said module, or dragging said module.

11. The computer program product of claim 7, wherein each one of said plurality of user interactions is associated with a weighted value.

12. The computer program product of claim 7, wherein said plurality of modules comprises syndicated modules.

13. A computer system comprising:
a processor unit;
a memory coupled to the processor unit; and
a Dynamic Module Placement (DMP) utility executing on the processor unit and having executable code for:
monitoring at least one of a plurality of user interactions associated with at least one of a plurality of modules;
assigning a rank value to a particular one of said plurality of modules, wherein said assigning step is based on said at least one of said plurality of user interactions; and
automatically displaying said particular one of said plurality of modules at a particular position on a content aggregated webpage, wherein said particular position is based on said assigned rank value.

14. The computer system of claim 13, wherein said assigning step is based on a usage count of said at least one of said plurality of user interactions.

15. The computer system of claim 13, wherein said assigning step is based on a usage pattern of said at least one of said plurality of user interactions.

16. The computer system of claim 13, wherein said at least one of said plurality of user interactions associated with said module includes: expanding a drop-down box, or closing said drop-down box, or selecting text, or highlighting text, or clicking on a hyperlink, or changing preferences, or inputting text, or focusing an icon over said module, or dragging said module.

17. The computer system of claim 13, wherein each one of said plurality of user interactions is associated with a weighted value.

18. The computer system of claim 13, wherein said plurality of modules comprises syndicated modules.
